(19) United States
(12) Patent Application Publication
(10) Pub. No.: US 2009/0031785 A1
(43) Pub. Date: Feb. 5, 2009

(54) Capacitively coupled dielectric barrier discharge detector

(75) Inventors: David G. Kellner, Urbana, IL (US); Matthew A. Castelein, Brooklyn, NY (US)

Correspondence Address: David G. Kellner, 60 Hazelwood, Champaign, IL, 61820, US

(73) Assignee: Caviton, Inc., Champaign, IL (US)

(21) Appl. No.: 12/220,855

(22) Filed: Jul. 29, 2008

Related U.S. Application Data
(60) Provisional application No. 60/962,762, filed on Jul. 31, 2007.

(51) Int. Cl. G01N 30/02

(52) U.S. Cl. 73/23.39

(57) ABSTRACT

A gas detector designed for use with a gas chromatography system, or alone, comprising a tubular inner electrode, a tubular outer electrode coaxial with the inner electrode, and a dielectric tube axially between the inner electrode and the outer electrode. The dielectric tube serves as a dielectric barrier between the inner electrode and the outer electrode. There is a longitudinal gap between the left end of the outer electrode and the right end of the inner electrode, and a sufficient voltage is applied across the gap between the electrodes to create an electrical discharge which emits light from a gas passing through the gap. The light is then detected and analyzed to determine the chemical constituents of the gas passing through the gap.

### FIELD OF THE INVENTION

This invention relates to gas detectors. More particularly, this invention relates to dielectric barrier micro-discharge gas detectors and gas chromatograph detector systems.

### BACKGROUND OF THE INVENTION

Gas chromatography is an analytical technique which entails the separation and often identification of individual compounds, or groups of compounds, within a mixture. A gas chromatography system takes a small sample of liquid or gas (typically about 0.1 cubic centimeter), and identifies the amounts of various compounds within the sample, often in the form of a chromatograph. A chromatograph is a line chart with the horizontal axis identifying different compounds and the vertical axis giving the concentration. The total amount of a compound in a given sample is usually related to the area under the peak associated with that particular compound. No other analytical technique is as powerful and as generally applicable as is gas chromatography. It is widely used in most sectors of chemistry, biology, forensics, environmental studies, and many areas of research.

A gas chromatography system is typically composed of three major subsystems: an injection chamber, a column separator, and a gas detector. Each of these subsystems usually has an independent means of temperature control. In order to analyze a sample, the sample is first injected into the injection chamber where a continual flow or pressure of a carrier gas (hydrogen, helium, nitrogen, air, etc.) is maintained. The injection chamber is usually maintained at a temperature such that various compounds within the sample are vaporized and enter the separation column.

The separation column is a long glass or metal tube which is coated on its interior surface by an inert compound designed to impede the flow of different compounds by different amounts. The separation column is typically about 1 to 30 meters long and has an inner diameter of about 50 microns (.mu.m) to 1 millimeter (mm). Even smaller columns have been fabricated in silicon substrates. The coating is referred to as the packing material and is one of the most important considerations when picking the desired column to analyze a particular sample. The carrier gas carries the evaporated compounds through the column. Different molecules diffuse through the column at different rates even though their stochastic differences may be small. A detailed analysis of compounds often involves the use of several columns with different packing materials.

Many different detection techniques are applied at the exit of the column to help create the desired chromatograph. Most importantly, the detector must be able to distinguish relative changes with respect to time of any physical property of the gas exiting the column. It is not necessarily important for the detector to identify the compounds exiting the column, but instead to be very sensitive to changes in composition of the exiting gas. Each detection system ideally leads to a chromatography system that may have particular advantages over other detectors for specific compounds. Some of the many types of detectors that are common include flame ionization detectors (FID), flame photometry detectors (FPD), nitrogen phosphorous detectors (NPD), electron capture detectors (ECD), thermal conductivity detectors (TCD), atomic emission detectors (AED), photoionization detectors (PID), electrical conductivity detectors (ELCD), mass spectrometer detectors (MS), discharge ionization detectors (DID), and chemiluminescence detectors.

Some detectors observe properties that can be measured without altering or destroying the gas being detected, such as thermal conductivity detectors. Most detectors, however, require external energy to excite or ionize the gas species, such as all flame-based detectors, ionization detectors and mass spectrometer detectors. These detection techniques often alter the compounds.

Each type of detector has its own advantages and disadvantages. They compete with each other primarily in their sensitivity to given classes of compounds, but also in dynamic range, linearity, universality, portability, and cost. Often, compromises among these categories have to be made for specific applications.

A means of converting the observation into an electrical signal is a property of all detectors. Voltage or current is ultimately measured as a function of time and the result displayed on a printout or computer monitor. These results are based on the initial time where the sample was injected into the gas chromatography system. The time between injection and each peak is specific to a particular compound or group of compounds. The instrument is calibrated by injecting a single known compound and measuring the time between the injection and the corresponding peak on the chromatograph. This process is repeated for all compounds of interest generating a table of delay times, often referred to as the retention time. The retention time for any compound will ideally be the same even if the compound is contained in a mixture of other compounds. However, these times vary for different columns. Injector chamber and column heating cycles also change the retention times.

Existing gas detectors suffer from several disadvantages. In particular, specific detectors giving mass or atomic species information tend to be large, expensive, and difficult to use. Non-specific detectors tend to be simple to use and inexpensive, but do not provide information about the chemicals being detected. This invention combines the specificity, low-cost, and sensitivity advantages that no other detector has previously achieved.

### SUMMARY OF THE INVENTION

The general object of this invention is to provide an improved gas detector. More particular objects are to provide a gas detector that is smaller and uses less power than existing gas detectors. Another object of this invention is to provide an improved gas chromatography system.

We have invented an improved gas detector, comprising a tubular inner electrode with a left end and a right end, an inside and an outside; a dielectric tube coaxial with the inner electrode, the dielectric tube with a left end and a right end, an inside and an outside, the right end of the inner electrode inside the left end of the dielectric tube; a tubular outer electrode coaxial with the inner electrode and the dielectric tube, the outer electrode with a left end and a right end, an inside and an outside, the right end of the dielectric tube inside the left end of the outer electrode; the inner electrode adapted to allow a gas to flow therethrough, and the dielectric tube adapted to allow the gas to flow therethrough; the dielectric tube serving as a dielectric barrier between the inner electrode and the outer electrode; a longitudinal gap between the left end of the outer electrode and the right end of the inner electrode; the electrodes adapted to connect to an AC voltage supply creating a voltage between the outer electrode and the inner electrode, the voltage acting across the longitudinal gap and through the dielectric barrier, the voltage creating a continuous plasma discharge within the gas; and a sensor adapted to detect changes in optical properties of the gas as it passes through the gap.

The gas detector of this invention is smaller and uses less power than existing gas detectors, while providing long-lived devices previously unachievable. Both optical and electrical signals can be measured from the discharge to serve as a time-dependent signal which generates a chromatograph. Geometrical, optical, and electrical variations can be applied to the device to alter its signal-to-noise ratio, sensitivity, dynamic range, and linearity.

### BRIEF DESCRIPTION OF THE DRAWINGS

FIG. 1 is a cross section of an embodiment of the gas detector of this invention.

FIG. 2 is a block diagram containing all parts of the gas detector system.

FIG. 3 is a block diagram showing the gas detector with a gas chromatography system in which the gas detector of this invention is advantageously used.

FIG. 4 is a block diagram showing a potential use of this gas detector for the detection of toxic chemicals in water.

### DETAILED DESCRIPTION OF THE INVENTION

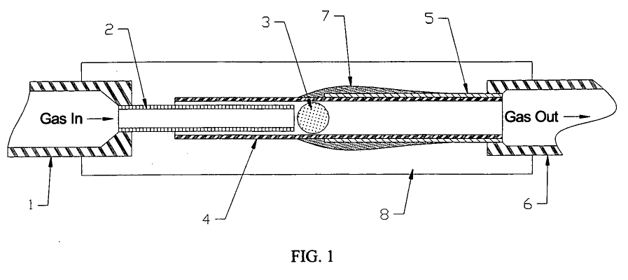

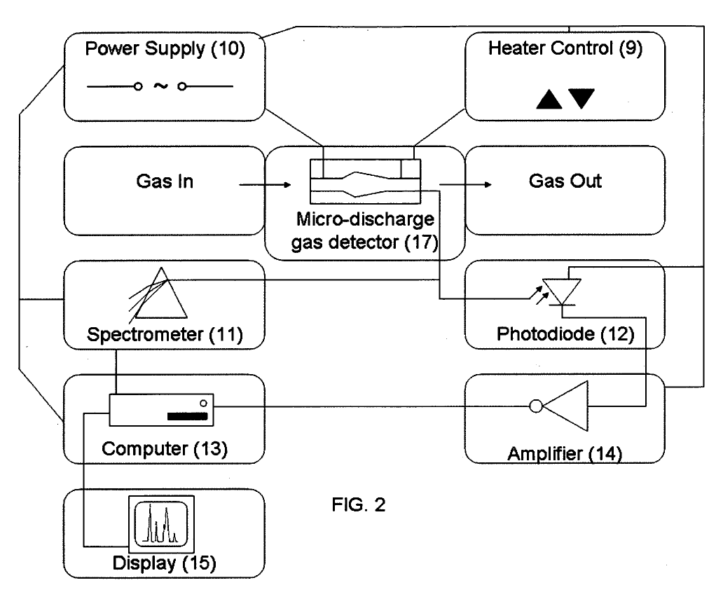

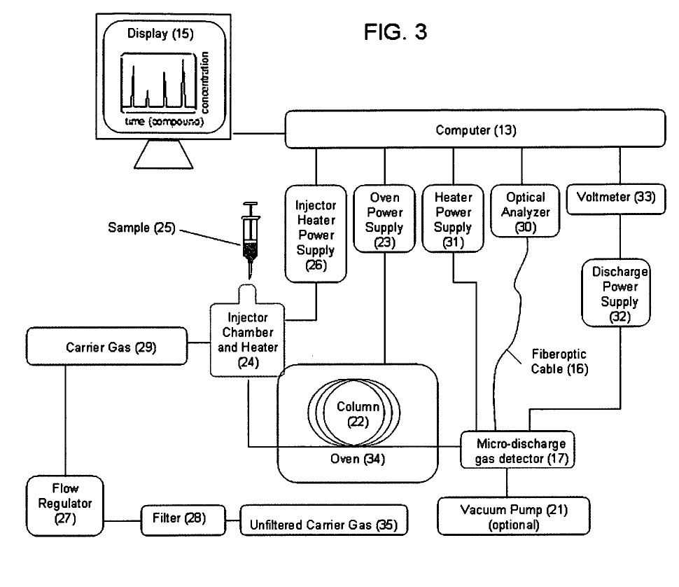

The gas detector of this invention is a capacitively coupled dielectric barrier discharge device, also called a micro-discharge gas detector (17, as shown in FIG. 2). In FIG. 1, the gas detector has an inner electrode 2 and an outer electrode 5, each made of hollow electrically conductive capillary tubing. The inner electrode 2 and outer electrode 5 are oriented coaxially. The inner electrode 2 and outer electrode 5 are separated longitudinally by a small gap as well as axially by a dielectric tube 4. An electric potential applied between the inner electrode 2 and outer electrode 5 creates an electrical discharge within a gas (also called a mixed gas composition, 20, as shown in FIG. 3)in the dielectric tube 4, at the gap (also called the discharge region 3) between the inner electrode 2 and the outer electrode 5. The discharge is characterized by the creation of a plasma. A plasma is electrically conductive due to the relatively high percentage of ions and electrons (electrically charged particles). During this process, the electrons in the atoms and molecules are excited to higher energy levels. As the electrons return to lower energy levels, photons of light are emitted at different wavelengths which are characteristic of the given atoms or molecules. Accordingly, the discharge has different optical and electrical characteristics depending on whether there are any compounds present other than a carrier gas (29, as shown in FIG. 3) in the mixed gas composition (20, as shown in FIG. 3), the mixed gas composition 20 comprising a carrier gas (29, as shown in FIG. 3) and a sample (25, as shown in FIG. 3). A capacitively coupled device is one that has a pair of conductors (the inner electrode 2 and the outer electrode 5) separated by a dielectric (the dielectric tube 4), whereby a current is applied across the device and opposite charges build up on the pair of conductors. By making the device capacitively coupled, the outer electrode 5 is protected from the discharge by a dielectric tube 4, and AC operation is possible without breakdown of the dielectric tube 4, or excessive heating that is experienced in other device designs and geometries. Additionally, the electric field is enhanced inside the dielectric tube 4, in the gap (discharge region, 3) between the electrodes (inner electrode 2 and outer electrode 5), leading to high energy densities, and high light output, increasing the light output and sensitivity of the device as compared to other microdischarge devices. These improvements to the devices have lead to increased lifetimes, increased light output and sensitivity, while simplifying construction, and reducing the cost of parts dramatically.

FIG. 1 shows a cross section of a first preferred embodiment of the gas detector. Gas (for example, from the output of a gas chromatograph column) enters the device through an inlet port 1 which guides the gas into the inner electrode 2. The gas then flows through the inner electrode 2, the discharge region 3 at the gap between the right end of the inner electrode 2 and the left end of the outer electrode 5, and the dielectric tube 4, before exiting the device through the outlet port 6. The dielectric tube 4 separates the inner electrode 2 and the outer electrode 5 and helps contain the gas in the discharge region 3 during operation. The dielectric tube 4 holds the capillary tubes a fixed distance apart at the discharge region by welds, solder, or adhesives as appropriate. In one embodiment, an epoxy adhesive is used to hold the capillary tubes a fixed distance apart. The dielectric tube 4 may be made of glass, quartz, alumina, sapphire, or any other suitable dielectric. The outer electrode 5 is covered by a dielectric coating 7 which protects the electrode from oxidation. In an alternate embodiment, gas may be guided through the outlet port 6 into the right end of the dielectric tube 4, the dielectric tube 4 communicating with the inner electrode 2, the gas then flowing from the right end of the inner electrode 2 to the left end of the inner electrode 2 and out the inlet port 1.

An optical fiber may be placed in either the inner electrode 2, or in the dielectric tube 4, near the discharge for coupling the light output. The optical fiber would communicate with the discharge region 3 at a first end and a photodiode (12, as shown in FIG. 2) or spectrometer (11, as shown in FIG. 2) at a second end, carrying the light from the discharge region to the photodiode or spectrometer.

A heater 8 brings the device to the desired operating temperature, if desired. The outer portions of the heater must also be electrically insulating to prevent discharges between the inlet and outlet ports. Electrical connections (not shown) are made directly to the expose electrode surfaces.

FIG. 2 is a block diagram showing all the parts of the detector system. A common or separate power supply 10 can be used to power the micro-discharge gas detector 17 and the computer 13. The heater (8, as shown in FIG. 1) of the micro-discharge gas detector 17 is not shown here. The heater (8, as shown in FIG. 1) may be controlled externally by a heater control 9. Gas enters the micro-discharge gas detector 17 at the inlet port (1, as shown in FIG. 1) to be detected, emits light as it passes through the discharge region (3, as shown in FIG. 1) and exits at the outlet port (6, as shown in FIG. 1). The light emitted in the discharge region (3, as shown in FIG. 1) is sent to a spectrometer 11 or a photodiode 12 so that data may be collected from the emitted light. In this embodiment, the micro-discharge gas detector 17 is connected to both a spectrometer 11 and a photodiode 12 for data collection purposes. An electrical signal from the photodiode 12 may be amplified by an amplifier 14 before it is sent to a computer 13 for data analysis and output. The signal from the spectrometer 11 may also be sent to a computer 13 for data analysis and output. The computer then analyzes the signals from the spectrometer 11 and the photodiode 12, as amplified by the amplifier 14. The computer processes the data and outputs charts and graphs on a display 15, the charts and graphs corresponding to the waveforms of the signals received by the computer. From the display 15, a user can determine the composition of the gas inputted into the micro-discharge gas detector 17.

FIG. 3 is a block diagram of a gas chromatograph system showing how the detector may be integrated with the rest of the instrument. An unfiltered carrier gas 35 is sent through a filter and a flow regulator to produce a carrier gas 29 to be combined with a sample 25. The sample 25 and carrier gas 29 are combined in the injection chamber and heater 24, the injection chamber and heater 24 powered by an injector heater power supply 26. The combined gas forms a mixed gas composition 20, which is sent to the column 22, the column which is contained in an oven 34 that controls the temperature of the column. As the mixed gas composition 20 exits the column, it is detected by the micro-discharge gas detector 17, as pictured in FIG. 1. The micro-discharge gas detector 17 is connected to a heater power supply 31 and a discharge power supply 32. The micro-discharge gas detector 17 is optionally connected to a vacuum pump 21. The output of the discharge power supply 32 is monitored by a voltmeter 33. Light emitted from the micro-discharge gas detector 17 is sent to an optical analyzer 30 such as a spectroscope (11 in FIG. 2) or a photodiode (12 in FIG. 2). Outputs from the voltmeter 33, the optical analyzer 30, the heater power supply 31, the oven power supply 23, and the injector heater power supply 26 are sent to a computer 13 for analysis, and the results are shown on a display 15 in the form of a graph or chart. In one embodiment, the display 15 is a monitor.

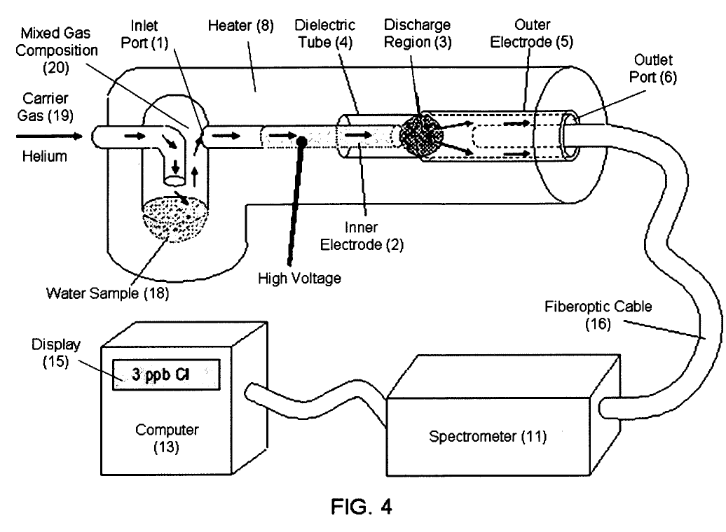

FIG. 4 shows how the detector can be set up with a heater to vaporize water and detect chemicals in the water as the vapor passes through the discharge. A carrier gas 19 such as helium passes over a water sample 18 being heated by a heater 8. The carrier gas 19 becomes mixed with a vapor from the heated water sample 18 as it passes, creating a mixed gas composition 20. The Arrows show the flow of gas. The mixed gas composition 20 then enters the micro-discharge gas detector 17 at the inlet port 1. The mixed gas composition 20 passes through the inner electrode 2 to the discharge region 3, where light is emitted from the mixed gas composition 20 in response to the potential between the inner electrode 2 and the outer electrode 5. The mixed gas composition 20 then passes through the dielectric tube 4 and exits the micro-discharge gas detector 17 through the outlet port 6. The light emitted from the mixed gas composition 20 in the discharge region 3 is collected by a fiberoptic cable 16, the fiberoptic cable 16 communicating with a spectrometer 11. The spectrometer 11 receives light from the fiberoptic cable 16, processes the light, and sends data to the computer 13 for analysis. The computer 13 processes the data and outputs concentration information corresponding to the mixed gas composition 20 on a display 15.

The detector generally operates at a pressure ranging from a few Torr to a few atmospheres. The gap between the inner electrode 2 and the outer electrode 5 is generally about 10 to 1000 microns. The inner diameter of the inner electrode 2 is generally about 10 to 1000 microns. When the gas detector is used with a gas chromatography system, the inner diameter of the inner electrode 2 is preferably about equal to the inner diameter of the gas chromatograph column (22, as shown in FIG. 3).

The inner electrode 2 is surrounded by a dielectric tube 4 slightly larger than the outer diameter of the inner electrode 2, and typically 50-1000 microns thick.

The outer electrode 5 is slightly larger in inner diameter than the dielectric tube 4, or, alternatively, may be directly applied as a metallic or other conductive coating on the outer surface of the dielectric. Additionally, the entire device may be coated in a dielectric (gas, liquid, or solid) to allow discharge formation only on the inside of the dielectric tubing.

The inner electrode 2 is made of a material that conducts electricity and that can be formed into tubing with the desired inner and outer diameters. The inner electrode 2 may be directly applied as a metallic or other conductive coating on the inner surface of the dielectric. The electrodes (inner electrode 2 and outer electrode 5) are preferably made of metal, and are most preferably made of stainless steel. The metal may be coated with an inert chemical to help system performance. A dielectric tube 4 surrounds the inner capillary tubing both to hold the metal tubing in place, provide the dielectric barrier between the electrodes (inner electrode 2 and outer electrode 5), and to contain gases in the discharge region 3. The dielectric tube 4 can be made of glass, ceramic or quartz with these primary considerations. First, the dielectric must be able to withstand the voltage applied across the dielectric barrier without itself breaking down. Second, the dielectric must be able to withstand the temperature cycles of the detection chamber and the temperature of the discharge itself.

A discharge is formed in the gas in the gap between the electrodes inside the dielectric tubing by applying voltage between the two electrodes. The gas detector is generally operated with an alternating current (AC) power supply capable of generating about 4 to 100 kilovolts at approximately 500 milliwatts to as much as 500 watts. The volume of the discharge ranges from about 100 picoliters (pl) to about 100 nanoliters (nl). When used with a gas chromatograph instrument, gas exiting the column flows through the detector. A voltage sufficient to sustain a current in the gas within the discharge region is applied between the inlet and outlet ports. When the detector is used without a gas chromatography system, a dilution gas of helium or other appropriate gas can be added to the dielectric tube or inner electrode to aid in emission properties of the detector, or can operate in air with no dilution gas.

The discharge emits light of different wavelengths which serves as an alternative or additional way to identify compounds. Each gas entering the discharge region 3 emits characteristic light, serving as a spectral fingerprint. In order to take advantage of this additional information, a small spectrometer 11 is utilized with the detector. The spectrometer 11 is an instrument used to identify the amount of light of different colors, typically sensitive to wavelengths from 200 nanometers (nm) (in the ultraviolet spectrum) to about 1000 nm (in the infrared spectrum). A fiberoptic cable 16 is a convenient way to carry the light from the discharge to the spectrometer for analysis. Alternatively, small and inexpensive photodiodes (12, as shown in FIG. 2) monitoring total light output, or combined with color filters for specificity, can be utilized with the detector body to look at specific colors emitted by the discharge. Total light output monitoring provides non-specific, but highly sensitive detection of chemicals entering the discharge. Specific color monitoring may be used when looking for only one or several compounds of interest that emit strong radiation at a specific wavelength such as chlorine or mercury. Photodiodes (12, as shown in FIG. 2) may be placed in close proximity to the discharge, or again, a fiberoptic cable 16 can deliver the light from the discharge region to the photodiode (12, as shown in FIG. 2).

A few operational parameters are important to keep in mind when utilizing the invention. First, the total gas pressure in the discharge region 3 will change the electron energy distribution function and the result is a change in sensitivity for selected molecules. Also, the temperature must be maintained to prevent thermal-induced voltage changes. The temperature can be maintained by a heater 8.

One of the primary benefits of the gas detector of this invention is its small size. The preferred embodiment shown in FIG. 1 has a length of about three centimeters and a diameter of less than one centimeter. Along with the gas detector's small size, the detector has a light weight and inherently low power consumption (suitable for battery power), which makes the detector especially adapted for use with portable gas chromatograph instruments.

If a vacuum pump (21, as shown in FIG. 3) is used to decrease the operating pressure of the discharge, the optical radiation emitted from the discharge will have a reduced linewidth. This often produces more atomic and molecular peaks within a given wavelength range. The additional peaks give more detailed information about the components in the discharge and may allow simultaneous detection of several different components. In other words, the number of components that can be identified is increased in the case where several components are present in the discharge at the same time.

Unlike detectors such as flame ionization detectors, this detector has no dilution of the gas exiting the column (22, as shown in FIG. 3). Flame ionization detection involves mixing hydrogen and air (or oxygen) with the column effluent before igniting this mixture. Thus, the column flow (30 mmin typical for a packed column) is mixed with hydrogen and air (500 mmin typical combined) diluting the gas being detected by a factor of 17. The dilution is even worse with capillary columns where a makeup gas (nitrogen typically) is mixed with the column (22, as shown in FIG. 3). In that case the gas exiting the column (22, as shown in FIG. 3) is diluted by a factor of 180 before detection. In contrast the gas detector of this invention forms a discharge directly in the gas (mixed gas composition, 20, as shown in FIG. 3) exiting the column without diluting the percentage of trace compounds within the gas. In addition, all associated equipment such as flow controllers, hydrogen and air filters, and a hydrogen source are eliminated, thus reducing the complexity, weight and size of the instrument.

A fiberoptic cable 16 (or multiple fibers) can be inserted into the ends of the body of the detector to transmit light from the discharge to various detectors such as a spectrometer 11 or photodiode (12, as shown in FIG. 2) for spectral analysis. Optical fibers can be smaller than one micron core diameter to larger than 500 microns. Since the discharge length is approximately 10 to 500 microns, optical fibers are of the proper size for use with the current invention. Fibers also have the property to filter light they collect. Thus, the proper choice of fiber diameter and material can serve as a filter to block light that is not of interest.

The detector can be used without the column (22, as shown in FIG. 3) for gas analysis as a “stand alone” gas detector. If the gas detector is inserted into the flowing gas of a smoke stack, for instance, the flow of gas would travel through the device and enter the discharge region 3 where spectral analysis would serve to identify the chemical species and the concentration of a desired species within the smoke stack.

If a means of injecting a micro-droplet of fluid were introduced, liquid samples could also be analyzed directly in the discharge region 3. An ink-jet printer head is capable of ejecting micron diameter sized droplets of fluid. A hole drilled through the dielectric tube 4, perpendicular to the gas flow, could serve as a means of introduction of the droplet into the discharge region 3. As the droplet enters the discharge region 3, it will be vaporized and optical emission from the vapors in the discharge region 3 can serve as compound identification to the constituents in the liquid. One application would be to inject automotive oil into the discharge to identify the concentration and type of metal for engine performance assessment. Also, a water sample 18 could be injected in the same manner to check for impurities or contaminants such as mercury. Additionally experiments have shown that the detector is capable of operation in saturated water vapor, allowing detection of chemicals directly from a water sample 18 by heating the water sample 18 and the detector to above the boiling point of the water.

When trace chemical detection is desired, several techniques can be used to increase the sensitivity. For these sensitivities, the gas being analyzed is passed over a material which absorbs the chemical of interest for several seconds or minutes. The material is subsequently heated to release the absorbed compounds at a much higher concentration than in the air being tested. This is a concentration technique which could be added to the input gas stream to improve system performance for demanding applications such as explosives detection or other trace airborne contaminants. Explosives do not interfere with the operation of the micro-discharge gas detector (17, as shown in FIG. 2) because ignition will not take place in the absence of oxygen. Also, very small quantities of explosives will only burn.

The detector may also be placed on a mobile platform (such as a remote controlled airplane) such that it can be transported to remote locations for chemical detection. This may be useful for organizations such as the military for early warning detection systems for approaching threats. The detector is ideal for this purpose since an entire system can be made which weighs less than about four pounds and consumes less than a watt of power and uses little space (under 200 cubic inches). The detector can be manufactured at a relatively low cost so the loss of such a mobile platform in flight would be tolerable.

| | |
|---|---|
| Item | Drawing Number |

| Number | Item Name | 1 | 2 | 3 | 4 |
|---|---|---|---|---|---|
| 1 | inlet port | x | | | x |
| 2 | inner electrode | x | | | x |
| 3 | discharge region | x | | | x |
| 4 | dielectric tube | x | | | x |
| 5 | outer electrode | x | | | x |
| 6 | outlet port | x | | | x |
| 7 | dielectric coating | x | | | |
| 8 | heater | x | | | |
| 9 | heater control | | x | | |
| 10 | power supply | | x | | |
| 11 | spectrometer | | x | | x |
| 12 | photodiode | | x | | |
| 13 | computer | | x | x | x |
| 14 | amplifier | | x | | |
| 15 | display | | x | x | x |
| 16 | fiberoptic cable | | | x | x |
| 17 | micro-discharge | | | x | |
| | detector | | | | |
| 18 | water sample | | | | x |
| 19 | carrier gas | | | | x |
| 20 | mixed gas | | | | x |
| | composition | | | | |
| 21 | vacuum pump | | | x | |
| 22 | column | | | x | |
| 23 | oven power supply | | | x | |
| 24 | injector chamber | | | x | |
| | and heater | | | | |
| 25 | sample | | | x | |
| 26 | injector heater | | | x | |
| | power supply | | | | |
| 27 | flow regulator | | | x | |
| 28 | filter | | | x | |
| 29 | carrier gas | | | x | |
| 30 | optical analyzer | | | x | |
| 31 | heater power | | | x | |
| | supply | | | | |
| 32 | discharge power | | | x | |
| | supply | | | | |
| 33 | voltmeter | | | x | |
| 34 | oven | | | x | |
| 35 | unfiltered carrier | | | x | |
| | gas | | | | |

I claim:

1. A gas detector comprising:
(a) a tubular inner electrode with a left end and a right end, an inside and an outside;
(b) a dielectric tube coaxial with the inner electrode, the dielectric tube with a left end and a right end, an inside and an outside, the right end of the inner electrode inside the left end of the dielectric tube;
(c) a tubular outer electrode coaxial with the inner electrode and the dielectric tube, the outer electrode with a left end and a right end, an inside and an outside, the right end of the dielectric tube inside the left end of the outer electrode;
(d) the inner electrode adapted to allow a gas to flow therethrough, and the dielectric tube adapted to allow the gas to flow therethrough;
(c) the dielectric tube serving as a dielectric barrier between the inner electrode and the outer electrode;
(d) a longitudinal gap between the left end of the outer electrode and the right end of the inner electrode;
(e) the electrodes adapted to connect to an AC voltage supply creating a voltage between the outer electrode and the inner electrode, the voltage acting across the longitudinal gap and through the dielectric barrier, the voltage creating a continuous plasma discharge within the gas; and
(f) a sensor adapted to detect changes in optical properties of the gas as it passes through the gap.

2. The gas detector of claim 1 wherein the outer electrode comprises a metallic or other conductive coating on the outside of the dielectric tubing.

3. The gas detector of claim 1 wherein the outer electrode comprises a metallic or other conductive coating on the inside of the dielectric tubing.

4. The gas detector of claim 1 wherein the sensor detects changes in optical properties by detecting a change in light emission.

5. The gas detector of claim 4 wherein the sensor is a photodiode.

6. The gas detector of claim 4 wherein the sensor is a spectrometer.

7. The gas detector of claim 4 wherein a fiberoptic cable carries light from a first end of the fiberoptic cable at an area communicating with the gap to a second end of the fiberoptic cable communicating with the sensor.

8. The gas detector of claim 7 wherein the fiberoptic cable passes through an opening in the inner electrode.

9. The gas detector of claim 7 wherein the fiberoptic cable passes through an opening in the dielectric tube.

10. The gas detector of claim 1 additionally comprising a means for generating a graph from the changes detected in optical properties of the gas.

11. The gas detector of claim 1 additionally comprising a heater adapted to maintain the entire detector at an elevated temperature.

12. The gas detector of claim 1 wherein the AC voltage supply provides about 1 to 100 kilovolts across the dielectric barrier between the outer electrode and the inner electrode.

13. The gas detector of claim 12 wherein the inner electrode has an inner diameter of about 10 to 1000 microns.

14. The gas detector of claim 13 wherein the dielectric tube has an inner diameter that closely fits the outer diameter of the inner electrode, the dielectric tube being about 50 to 1000 microns thick.

15. The gas detector of claim 14 wherein the outer electrode is a conductive coating directly applied to the dielectric tube.

16. The gas detector of claim 14 wherein the outer electrode is made from capillary tubing that closely fits the dielectric tube.

17. The gas detector of claim 16 wherein the dielectric tube is made of glass, ceramic, or quartz.

18. The gas detector of claim 17 wherein the outside of the outer electrode is covered with a dielectric.

19. The gas detector of claim 17 wherein a dilution gas is supplied through the dielectric tube.

20. The gas detector of claim 17, wherein a dilution gas is supplied through the inner electrode.

21. The gas detector of claim 1, wherein the gas flows into the inner electrode at the left end of the inner electrode and out of the inner electrode at the right end of the inner electrode, the right end of the inner electrode communicating with the left end of the dielectric tube, the gas then flowing from the left end of the dielectric tube and out the right end of the dielectric tube.

22. A gas chromatography system comprising:
(a) an injection chamber for introducing a sample;
(b) a column separator through which the sample flows as a gas;
(c) a tubular inner electrode with a left end and a right end;
(d) a dielectric tube with a left end and a right end, the right end of the inner electrode coaxially within the left end of the dielectric tube;
(e) a tubular outer electrode with a left end and a right end, the right end of the dielectric tube coaxially within the left end of the outer electrode;
(f) the inner electrode adapted to allow a gas to flow therethrough, and the dielectric tube adapted to allow the gas to flow therethrough;
(g) the dielectric tube serving as a dielectric barrier between the inner electrode and the outer electrode;
(h) a longitudinal gap between the left end of the outer electrode and the right end of the inner electrode;
(i) the electrodes adapted to connect to an AC voltage supply creating a voltage between the outer electrode and the inner electrode, the voltage acting across the longitudinal gap and through the dielectric barrier, the voltage creating a continuous plasma discharge within the gas; and
(j) a sensor adapted to detect changes in optical properties of the gas as it passes through the gap.

23. The gas chromatography system of claim 22 wherein the outer electrode comprises a metallic coating on the outside of the dielectric tubing.

24. The gas chromatography system of claim 22 wherein the outer electrode comprises a metallic or other conductive coating on the inside of the dielectric tubing.

25. The gas chromatography system of claim 22 wherein the sensor detects changes in optical properties by detecting a change in light emission.

26. The gas chromatography system of claim 25 wherein a fiberoptic cable carries light from a first end of the fiberoptic cable at an area communicating with the gap to a second end of the fiberoptic cable communicating with the sensor.

27. The gas detector of claim 26 wherein the fiberoptic cable passes through an opening in the inner electrode.

28. The gas detector of claim 26 wherein the fiberoptic cable passes through an opening in the dielectric tube.

29. The gas chromatography system of claim 22 additionally comprising a means for generating a graph from the changes detected in optical properties of the gas.

30. The gas chromatography system of claim 22 additionally comprising a heater adapted to sustain the gas at a constant temperature.

31. The gas chromatography system of claim 22 wherein the AC voltage supply provides about 1 to 100 kilovolts across the dielectric barrier between the outer electrode and the inner electrode.

32. The gas chromatography system of claim 31 wherein the inner electrode has an inner diameter of about 10 to 1000 microns.

33. The gas chromatography system of claim 32 wherein the dielectric tube has an inner diameter that closely fits the outer diameter of the inner electrode, the dielectric tube being about 50 to 1000 microns thick.

34. The gas chromatography system of claim 33 wherein the outer electrode is a conductive coating directly applied to the dielectric tube.

35. The gas chromatography system of claim 33 wherein the outer electrode is made from capillary tubing that closely fits the dielectric tube.

36. The gas chromatography system of claim 35 wherein the dielectric tube is made of glass, ceramic, or quartz.

37. The gas chromatography system of claim 36 wherein the outside of the outer electrode is covered with a dielectric.

38. The gas chromatography system of claim 37 wherein a dilution gas is supplied through the dielectric tube.

39. The gas chromatography system of claim 37, wherein a dilution gas is supplied through the inner electrode.

40. The gas chromatography system of claim 18, wherein the gas flows into the inner electrode at the left end of the inner electrode and out of the inner electrode at the right end of the inner electrode, the right end of the inner electrode communicating with the left end of the dielectric tube, the gas then flowing from the left end of the dielectric tube and out the right end of the dielectric tube.
